(19) United States
(12) Patent Application Publication
(10) Pub. No.: US 2026/0195223 A1
(43) Pub. Date: Jul. 9, 2026

(54) OPTIMAL BLOCK REPAIRS IN GEO-DISTRIBUTED STORAGE SYSTEMS

(71) Applicant: NEXODATA SHAREHOLDINGS CORP., CALGARY (CA)

(72) Inventors: Pak Ching LEE, CALGARY (CA); Si WU, CALGARY (CA); Kwok Sing NG, CALGARY (CA); Shakeel Salamat Ullah, CALGARY (CA)

(21) Appl. No.: 19/009,216

(22) Filed: Jan. 3, 2025

(51) Int. Cl. G06F 11/16; G06F 11/10

(52) U.S. Cl. CPC G06F 11/1612; G06F 11/1048; G06F 11/1662

(57) ABSTRACT

An application of two-level erasure coding and two data repair methods to achieve minimum cross-rack and cross-region data repair transfer in geo-distributed storage systems that comprise storage nodes, racks, and regions, is disclosed. The systems apply erasure coding to divide data into rows and columns of blocks and generate redundancy at the storage node and rack levels to tolerate failures of storage nodes, racks, and a single region. Minimum cross-rack and cross-region data repair traffic is achieved by (i) repeated repairs of in-rack block failures in parallel and cross-rack block failures on the row with the maximum number of failed blocks; and (ii) in a row repair, minimizing the number of regions, and if there is one failed block and the number of surviving blocks in each region is greater than one, partially decoding blocks at a rack in each region.

### FIELD OF THE INVENTION

The present disclosure relates to the computing field, and more specifically to data processing and management of data storage systems.

### BACKGROUND

Geo-distributed storage systems store massive amounts of data across geographical regions to provide proximal and scalable user access, while ensuring data availability even in the face of catastrophic failures such as earthquakes and power outages. To safeguard data storage against node and rack failures within a region, as well as regionwide failures, modern geo-distributed storage systems employ erasure coding to stripe low-cost redundancy across geographical regions. At a high level, an erasure code encodes a group of data blocks into parity blocks, in which the data and parity blocks collectively form a stripe, such that any subset of a sufficient number of data and parity blocks within a stripe can reconstruct all original data blocks. Compared to replication, erasure coding significantly reduces the amount of redundancy, while offering much higher reliability measured by mean-time-to-data-loss. This makes erasure coding particularly well-suited for exascale data management in geo-distributed storage systems.

To maintain data availability, storage systems frequently perform data repair operations due to the prevalence of node, rack, and region failures. In traditional erasure-coded storage, a majority of stripes with failures experience a single failed block, and hence existing erasure codes often focus on optimizing single-block repairs. However, in catastrophic events or zone maintenance, rack and region failures can occur, thereby causing multiple blocks to become unavailable (such failed blocks can belong to the same stripe). Also, wide stripes, which comprise a large number of data blocks and a small number of parity blocks, are increasingly studied and deployed to achieve ultra-low storage redundancy, and the likelihood of having multiple failed blocks in wide stripes is non-negligible. Thus, both single-block and multi-block repairs are critical in large-scale erasure-coded storage and should be simultaneously optimized.

Achieving optimal single-block and multi-block repairs for erasure-coded storage is non-trivial, as they trigger substantial network transfers in order to retrieve multiple available blocks of the same stripe for reconstruction of any failed blocks. The repair penalty becomes more prominent in geo-distributed storage systems, in which substantial cross-rack and cross-region data transfers are necessary for block repairs. Previous proposals in the literature on repair-efficient erasure codes, such as Regenerating Codes, Locally Repairable Codes (LRCs), and hierarchy-aware erasure codes for rack-based data centers still fall short in optimizing both single-block and multi-block repairs for geo-distributed storage systems with nodes, racks, and regions.

### SUMMARY

This disclosure provides systems and methods on data management for (i) employing two levels of erasure codes on data within and across racks to tolerate failures of storage nodes, racks, and a single region; (ii) repairing single and multiple failed data blocks at storage node, rack, and region levels with minimum cross-rack and cross-region data transfers; and (iii) repairing single and multiple failed data blocks at rack and region levels with minimum cross-rack and cross-region data transfers.

The first embodiment is a data management system comprises more than one storage nodes, racks, regions, and networks. The storage nodes, racks, and regions, are connected via the networks. Each rack comprises at least k₂+m₂ storage nodes, where k₂ and m₂ are positive integers. Each region comprises m₁ racks, where m₁ is a positive integer. When the system takes a unit of input data, it divides the data into a set of data blocks and arranges all data blocks in a two-dimensional array of k₁ columns and k₂ rows, where k₁ is a positive integer. It encodes each row of data blocks into m₁ row parity blocks using an erasure code and expands the array by m₁ columns. For the row parity blocks in each row, it adds one block to each of the additional m₁ columns. The system also encodes each column of data blocks into m₂ column parity blocks using an erasure code and expands the array by m₂ rows. For the column parity blocks in each column, it adds one block to each of the additional m₂ rows. The system stores all blocks in the same column in the same rack, at most one block in a row in each rack, and at most one block for each unit of input data in each storage node.

The system in the first embodiment further generates global parity blocks from either column parity blocks or row parity blocks. The generation of global parity blocks from column parity blocks is row-wise. For each row of column parity blocks, the system encodes the column parity blocks into m₁ global parity blocks and adds one global parity block to each of the m₁ columns that contain row parity blocks. The generation of global parity blocks from row parity blocks is column-wise. For each column of row parity blocks, the system encodes the row parity blocks into m₂ global parity blocks and adds one global parity block to each of the m₂ rows that contain column parity blocks. For all global parity blocks, the system stores each block in the rack of its corresponding column.

The second embodiment is a data repairing method for single-block and multi-block failures at storage node, rack, and region levels with minimum cross-rack and cross-region data transfer. The method takes a unit of input data with failed blocks as input. It checks and reports data loss if the set of failed blocks forms a grid that spans (m₂+1) adjacent rows and (m₁+1) adjacent columns, which indicates the set of failed blocks cannot be repaired. Otherwise, it repeats the following two steps until all failed blocks are repaired: (i) find all columns with no more than m₂ failed blocks and repair all failed blocks in these columns in parallel; and (ii) find the rows with no more than m₁ failed blocks, select the row with the maximum number of failed blocks, and repair all failed blocks in the selected row.

The third embodiment is a data repairing method for single-block and multi-block failure at rack and region levels with minimum cross-rack and cross-region data transfer. The method takes a row of blocks that has f failed blocks as input, where f is a positive integer. It then selects a region as the main region and a rack as the main rack. It further selects the smallest number of helper regions, such that the total number of surviving blocks in this row in all helper regions and the main region is at least k₁. When either of the conditions (i) f>1; or (ii) f=1 and the number of surviving blocks in each helper region equals one; matches, the method transfers k₁ surviving blocks to the main rack. Otherwise (i.e., when f=1 and the number of surviving blocks in each helper region is greater than one), in each helper region, the method selects a rack that stores at least one surviving block as the relay, collects other surviving blocks in racks within the same region at the relay, computes a partially decoded block at the relay using an erasure code and the collected surviving blocks, and transfers the partially decoded block to the main rack. The method then decodes the f failed blocks in the main rack. Finally, the method redistributes the decoded f blocks from the main rack to other racks and regions.

### BRIEF DESCRIPTION OF THE DRAWINGS

For a more complete understanding of the invention, reference is made to the following description and accompanying drawings, in which:

FIG. 1 depicts the architecture of geo-distributed storage systems;

FIG. 2 illustrates data block repairs under RS(6,3) codes for single-block failures (upper) and multi-block failures (lower) in a geo-distributed storage system, respectively, where the storage system comprises three regions, two racks per region, and two nodes per rack;

FIG. 3 illustrates data block repairs under LRC(6,2,2) codes for single-block failures (upper) and multi-block failures (lower) in a geo-distributed storage system, respectively, where the storage system comprises three regions, two racks per region, and two nodes per rack;

FIG. 4 shows a construction of LPC(k₁, m₁, k₂, m₂, r), where k₁=4, m₁=2, k₂=2, m₂=1, and r=3 in a geo-distributed storage system that comprises three regions, two racks per region, and three storage nodes per rack;

FIG. 5 illustrates block repairs in LPC(4, 2, 2, 1, 3) on single-block failures (upper) and multi-block failures (lower) in a geo-distributed storage system that comprises three regions, two racks per region, and three nodes per rack;

FIG. 6 illustrates rack repairs (upper) and region repairs (lower) in LPC(4, 2, 2, 1, 3) in a geo-distributed storage system that comprises three regions, two racks per region, and three nodes per rack;

FIG. 7 is a flowchart of the first disclosed data repairing method; and

FIG. 8 is a flowchart of the row repair in the second disclosed data repairing method.

### DETAILED DESCRIPTION

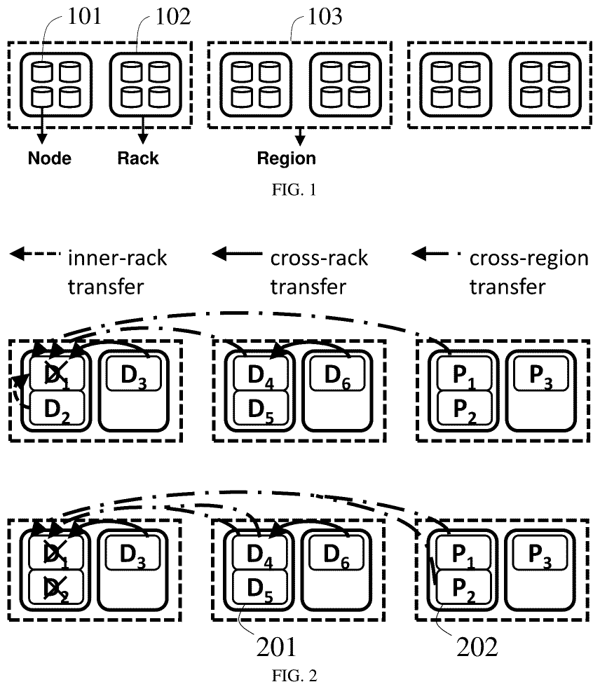

The disclosed invention is applicable to geo-distributed storage systems with a hierarchical topological structure as observed in production (e.g., Facebook f4 and Microsoft Giza), as shown in FIG. 1. Such a geo-distributed system organizes multiple nodes 101 in a rack 102, and further organizes multiple racks in a region 103, such that the entire storage system spans a number of nodes 101, racks 102, and regions 103. On fault tolerance, such geo-distributed storage systems place data with redundancy across distinct nodes and regions for multi-node fault tolerance and whole-region fault tolerance in case of catastrophic events. In practice, as whole-region failures happen much less rarely than node failures, single-region fault tolerance (a similar concept, called single-cluster fault tolerance, is found in prior studies) is the focus. As a region comprises multiple racks, single-region fault tolerance implies multi-rack fault tolerance. Cross-rack data transfers are typically much slower than inner-rack data transfers due to limited cross-rack bandwidth, and cross-region data transfers are also slow as they traverse different geographic regions. Thus, both cross-rack and cross-region transfers are the performance bottlenecks in data access.

The disclosed invention involves the data processing concepts in two stateof-the-art families of erasure codes, Reed-Solomon (RS) Codes and Locally Repairable Codes (LRCs), which also apply to hierarchical topologies. A summary of the two and their application to geo-distributed storage systems is included for reference as follows.

An RS Code, denoted by RS(k,m), is configured by two parameters k and m. RS(k,m) encodes k original data blocks 201 (denoted by D₁,D₂, . . . ,Dₖ) into m additional parity blocks 202 (denoted by P₁,P₂, . . . ,Pₘ), such that any k out of the k+m blocks can recover all k original data blocks 201; in other words, it tolerates the failures of any m out of the k+m blocks. The k+m blocks that are encoded together collectively form a stripe. A geo-distributed storage system stores many stripes that are independently encoded. FIG. 2 shows an example of RS(6,3) with k=6 data blocks 201 and m=3 parity blocks 202.

The encoding and decoding of RS Codes are based on the arithmetic in Galois Field GF(2^{w}) in w-bit words. Each data/parity block (say B) in RS(k,m) is encoded or decoded by computing a linear combination of k data/parity blocks (say B₁,B₂, . . . ,Bₖ) of the same stripe as

$$B = {\sum }_{i = 1}^{k} {α}_{i} {B}_{i}$$

for some coding coefficients αᵢ's, where additions are bitwise-XORs. Linear combinations satisfy additive associativity, meaning that the terms αᵢβᵢ's can be grouped in arbitrary order in additions.

RS Codes minimize the storage redundancy (i.e.,

$$1 + \frac{m}{k}$$

times the original data size) to tolerate the loss of any m out of k+m blocks; this property is called maximum distance separable (MDS). However, RS Codes have a high repair penalty: the repair of any lost block in RS(k,m) needs to retrieve k surviving blocks of the same stripe (i.e., k times the block size). For example, in FIG. 2, the repair of D₁ in RS(6,3) needs to retrieve D₂, D₃, D₄, D₅, D₆, and P₁.

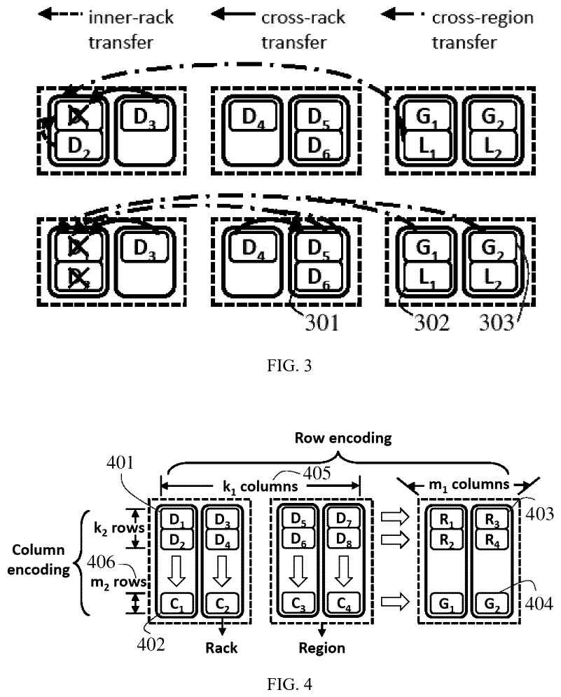

An LRC, denoted by LRC(k,l,g), is configured by three parameters k, l, and g. LRC(k,l,g) encodes k data blocks 301 into l local parity blocks 302 (denoted by L₁,L₂, . . . ,Lₗ) and g global parity blocks 303 (denoted by G₁, G₂, . . . , G_{g}), such that the k+l+g blocks form a stripe. There are various code constructions for LRCs, among which Azure's Local Reconstruction Codes can tolerate the loss of most blocks under the same storage redundancy. Suppose that k is divisible by l. LRC(k,l,g) divides k data blocks 301 evenly into/local groups and computes a local parity block 302 based on bitwise-XORs of the k/l data blocks in each local group. It further encodes all k data blocks into g global parity blocks 303 as in RS Codes. For example, FIG. 3 shows an example of LRC(6,2,2) with k=6 data blocks 301, l=2 local parity blocks 302, and g=2 global parity blocks 303.

LRCs exploit stripe locality to improve repair efficiency. In LRC(k,l,g), the repair of a lost data block or local parity block only retrieves the remaining-surviving blocks within the same local group, while the repair of a lost global parity block still retrieves k out of the k+g−1 surviving data blocks and global parity blocks. For example, in FIG. 3, the repair of D₁ in LRC(6,2,2) retrieves D₂, D₃, and L₁, while the repair of G₁ retrieves k=6 blocks from D₁ to D₆, and G₂.

Under single-region fault tolerance, RS(k,m) can place up to m blocks of an RS stripe in one region, while LRC(k,l,g) can place up to g+j (1≤j≤l) blocks of an LRC stripe that span j local groups in one region since the number of local/global parity blocks that can be used for decoding is g+j. For example, in FIG. 2, RS(6,3) places three blocks in one region (i.e., three regions in total for an RS stripe), while in FIG. 3, LRC(6,2,2) places every g+1=3 data blocks in one region and all parity blocks in a separate region (i.e., three regions in total for an LRC stripe). Both examples achieve single-region fault tolerance.

A system disclosed herein focuses on efficient single-block and multi-block repairs, which reconstructs single and multiple failed blocks of a stripe, respectively, by retrieving other available blocks of the same stripe. Cross-rack and cross-region transfers are the performance bottlenecks in repairs. The disclosed system applies two data repairing methods disclosed herein to minimize the sum of the amounts of traffic in cross-rack and cross-region transfers for a repair.

As failures can occur at the node, rack, and region levels, any failed node, rack, or region should be repaired as fast as possible to mitigate the risk of encountering additional failures that lead to data loss. For a single node failure, its repair can be viewed as a set of single-block repairs, each of which reconstructs the failed block of a stripe that covers the failed node. Similarly, for a failed rack or region, their repairs can be viewed as a set of single-block and multi-block repairs across all affected stripes. Thus, the data repairing methods disclosed herein that optimize single-block and multi-block repairs are applicable to the repair of a failed node, rack, and region.

The disclosed system applies a new family of erasure codes called Leveled Product Codes (LPCs)) based on Product codes for data storage. LPCs incorporate hierarchical awareness and stripe locality. Specifically, LPCs comprise three levels: (i) node level: LPCs realize a column-based RS Code across nodes inside a rack to localize single-block repairs and tolerate node failures; (ii) rack level: LPCs realize a row-based RS Code across racks to optimize multi-block repairs and tolerate rack failures; (iii) region level: LPCs realize region-aware data placement for single-region fault tolerance. LPCs localize single-block repairs inside racks. Also, LPCs decompose multi-block repairs into a minimum number of row repairs and a maximum number of column repairs, in which row repairs are done by retrieving only a subset of blocks, so that column repairs are later done locally within racks.

The construction and data placement method of LPCs in the disclosed system is elaborated as follows. An LPC is constructed with five parameters k₁, m₁, k₂, m₂, and r, denoted by LPC(k₁,m₁,k₂,m₂,r). It comprises RS(k₁,m₁) in the row direction and RS(k₂,m₂) in the column direction (note that RS Codes can be replaced by any MDS codes). Thus, an LPC stripe forms a (k₂+m₂)× (k₁+m₁) two-dimensional logical array with storage redundancy

$$( 1 + \frac{{m}_{1}}{{k}_{1}} ) ( 1 + \frac{{m}_{2}}{{k}_{2}} ) .$$

Each LPC stripe is distributed across r regions. The construction and data placement method of LPC comprises three steps.

In Step 1, the disclosed system organizes k₁k₂ data blocks 401, denoted by D₁, D₂, . . . , Dₖ₁ₖ₂, into a k₂×k₁ logical array in column-major order. The disclosed system encodes each of the k₁ columns 405 of k₂ data blocks 401 to form m₂ column parity blocks 402, and labels all k₁m₂ column parity blocks 402 (i.e., a m₂×k₁ logical array) by
C₁, C₂, . . . , Cₖ₁ₘ₂ in column-major order.

In Step 2, the disclosed system encodes each of the k₂ rows 406 of k₁ data blocks 401 to form m₁ row parity blocks 403, and labels all k₂m₁ row parity blocks 403 (i.e., a k₂×m₁ logical array) by R₁, R₂, . . . , Rₖ₂ₘ₁ in column-major order. The disclosed system also encodes each of the m₂ rows of k₁ column parity blocks 402 to form m₁ global parity blocks 404, and labels all m₁m₂ global parity blocks 404 (i.e., a m₂×m₁ logical array) by
G₁, G₂, . . . , Gₘ₁ₘ₂ in column-major order.

In Step 3, the disclosed system distributes each column 405 of k₂+m₂ blocks into k₂+m₂ distinct nodes, where each column 405 resides in a distinct rack. The disclosed system also co-locates every m₁ of the k₁+m₁ racks in one region, so an LPC stripe is stored in

$$⌈ \frac{{k}_{1}}{{m}_{1}} ⌉ + 1$$

regions.

FIG. 4 shows an LPC(4,2,2, 1,3) stripe with k₁k₂=8 data blocks 401, m₁=2 row parity blocks 403 for each row of data blocks 401, and m₂=1 column parity block 402 for each column 405 of data blocks 401. The stripe spans r=3 regions.

Regarding the generation of global parity blocks 404, one embodiment to generate each global parity block 404 is by encoding the column parity blocks 402 in the same row 406 using the row-based RS Code. Another embodiment to generate each global parity block is by encoding the row parity blocks 403 in the same column 405 using the column-based RS Code.

The fault tolerance guarantees of LPCs is summarized as follows: (i) LPC(k₁,m₁,k₂,m₂,r) can tolerate any m₁ failed blocks in each row or any m₂ failed blocks in each column; (ii) LPC(k₁,m₁,k₂,m₂,r) can tolerate the failed blocks that span no more than m₂ rows or m₁ columns; (iii) LPC(k₁,m₁,k₂,m₂,r) can tolerate any f=im₁+jm₂−m₁m₂ block failures that span i (m₂<i≤k₂+m₂) rows and j (m₁<j≤k₁+m₁) columns if and only if the failed blocks do not contain any (m₂+1)× (m₁+1) block matrix; (iv) LPC(k₁,m₁,k₂,m₂,r) tolerates the failures of any m₁ racks; and (v) LPC(k₁,m₁,k₂,m₂,r) tolerates the failure of a single region.

The first data repairing method disclosed herein takes a progressive approach to allow LPCs to perform a multi-block repair even with more than m₂ failed blocks in the same column. Specifically, LPCs execute row repairs to decode some failed blocks across the affected columns, so that column repairs can locally decode the remaining failed blocks within racks. As a column repair can be executed completely inside a rack while a row repair involves block accesses across racks and regions, the data repairing method disclosed herein executes the maximum possible number of column repairs and the minimum possible number of row repairs in a multi-block repair. As a result, the data repairing method disclosed herein minimizes the sum of cross-rack and cross-region transfers.

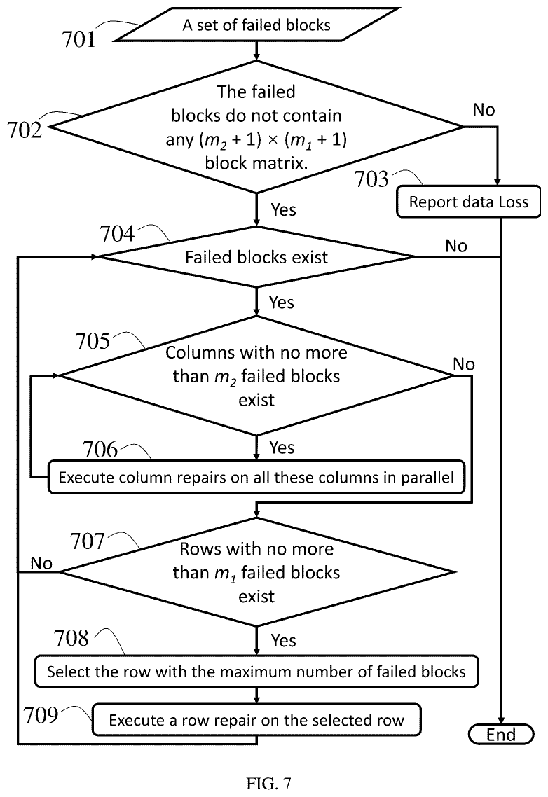

FIG. 7 shows the steps of the first data repairing method disclosed herein. The disclosed data repairing method first checks if a set of failed blocks 701 can be repaired (i.e., the set of failed blocks does not contain any (m₂+1)×(m₁+1) block matrix) 702 and returns “data loss” 703 if the set of failed blocks cannot be repaired. The disclosed data repairing method next finds all columns with no more than m₂ failed blocks 705 and executes column repairs on these columns in parallel 706. The disclosed data repairing method then finds the rows with no more than m₁ failed blocks 707, selects the row with the maximum number of failed blocks 708, and executes a row repair on the selected row 709. The disclosed data repairing method repeats the executions of column repairs and a row repair until all failed blocks are repaired 704.

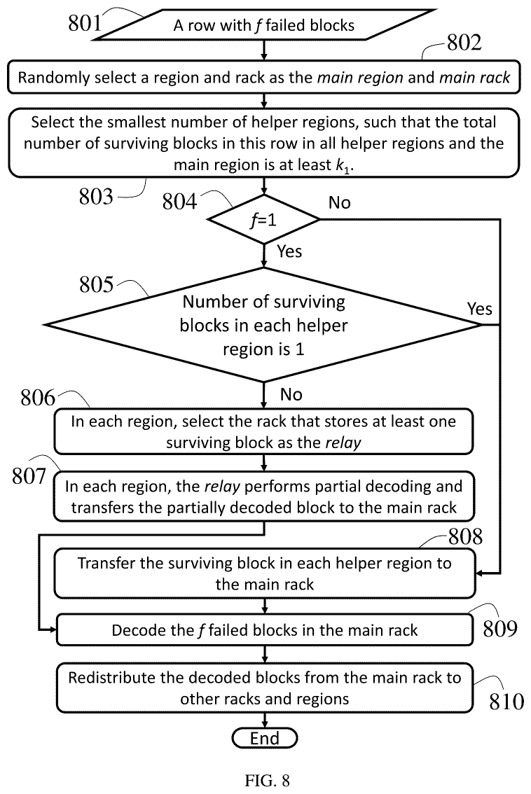

FIG. 8 illustrates the steps of a row repair for repairing f failed blocks in a row in the second disclosed data repairing method, which is elaborated as follows:

In Step 1, the disclosed system randomly selects a region and a rack as the main region and the main rack, respectively 802.

In Step 2, the disclosed system selects the smallest number of helper regions, such that the total number of surviving blocks in this row in all helper regions and the main region is at least k₁ 803.

In Step 3, the disclosed system considers two cases: f=1 and f>1. If f=1 804 and the number of surviving blocks in each helper region is one 805, then the disclosed system directly transfers the surviving block to the main rack 808. If f=1 and the number of surviving blocks in each helper region is greater than one, in each helper region, the disclosed system selects the rack that stores at least one surviving block as the relay 806, which performs partial decoding and transfers a partially decoded block 807 to the main rack. Specifically, the relay collects other surviving blocks across racks within the same region, computes a partially decoded block, and transfers the partially decoded block to the main rack. If f>1, the disclosed system directly transfers the surviving blocks to the main rack 808.

In Step 4, the disclosed system decodes all failed blocks in this row in the main rack 809.

In Step 5, the disclosed system redistributes the decoded blocks from the main rack to other racks and regions 810.

Following is an analysis of a row repair on the cross-rack and cross-region transfers, with the assumption that k₁ is divisible by m₁, such that each region stores exactly m₁ blocks in a row. In the main region, suppose that there are x failed blocks and m₁−x surviving blocks; in other words, in the helper regions, there are f−x failed blocks.

First, consider f>1. Suppose that the main rack contains one failed block. Then, the disclosed system accesses m₁−x surviving blocks across racks in the main region and k₁−m₁+x surviving blocks across regions from the helper regions for decoding. After decoding, the disclosed system re-distributes x−1 decoded blocks across racks in the main region and f−x decoded blocks to other regions. Thus, the numbers of crossrack and cross-region transfers are m₁−1 and k₁−m₁+f blocks, respectively. Note that the disclosed system can obtain the same numbers even if the main rack contains one surviving block. This implies that the random selection of the main region and main rack has no impact on the numbers of cross-rack and cross-region transfers.

As a result, the sum of cross-rack and cross-region transfers is fixed as k₁+f−1 blocks. We explain why the disclosed system excludes partial decoding for f>1. In Step 3, suppose there are s>f surviving blocks in one helper region and the disclosed system directly transfers the s blocks across regions. If the disclosed system applies partial decoding instead, then the relay accesses s−1 blocks across racks, computes, and transfers f blocks corresponding to the failed blocks. This results in a decrease in the number of cross-region blocks by s−f, but an increase in the number of cross-rack blocks by s−1, i.e., the sum of cross-rack and cross-region transfers increases.

Next, consider f=1. There are

$$\frac{{k}_{1}}{{m}_{1}} - 1$$

helper regions with m₁ surviving blocks (and a last helper region with one surviving block). In Step 3, in each such helper region, the number of cross-region blocks decreases by m₁−1 and the number of cross-rack blocks increases by m₁−1 by applying partial decoding (i.e., the sum keeps unchanged). From (i), the numbers of cross-rack and cross-region blocks are

$${m}_{1} - 1 + ( \frac{{k}_{1}}{{m}_{1}} - 1 ) ( {m}_{1} - 1 ) = {k}_{1} - \frac{{k}_{1}}{{m}_{1}} and$$

$${k}_{1} - {m}_{1} + 1 - ( \frac{{k}_{1}}{{m}_{1}} - 1 ) ( {m}_{1} - 1 ) = \frac{{k}_{1}}{{m}_{1}} ,$$

respectively. Thus, the numbers of cross-rack and cross-region blocks are

$$\# ( cross - rack blocks ) = \{ \begin{matrix}{k}_{1} - \frac{{k}_{1}}{{m}_{1}} , if f = 1 \\ {m}_{1} - 1 , if f > 1\end{matrix} and$$

$$\# ( cross - region blocks ) = \{ \begin{matrix}\frac{{k}_{1}}{{m}_{1}} , if f = 1 \\ {k}_{1} - {m}_{1} + f , if f > 1\end{matrix} ,$$

respectively, where f is the number of failed blocks in a row.

If k₁ is not divisible by m₁, the sum of cross-rack and cross-region transfers stays unchanged (i.e., k₁+f−1) and is not affected by the number of blocks in a region. However, the individual numbers of cross-rack and cross-region blocks may be different. For f=1, the two numbers are decided by the numbers of surviving blocks (which may be diverse) in the helper regions, while for f>1, the two numbers are determined by the number of blocks in the main region.

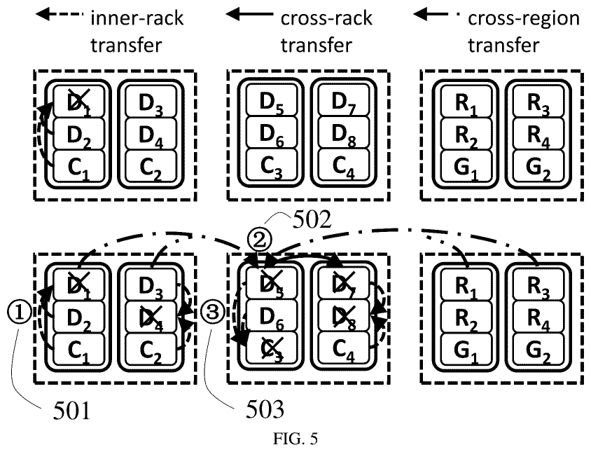

For example, in FIG. 5, the multi-block repair of D₁, D₄, D₅, D₇, D₈, and C₃ works as follows. The system first executes two column repairs for D₁ and D₄ 501. The disclosed system then selects the first row and executes a row repair to decode D₅ and D₇ 502. Specifically, the disclosed system selects the second region and the first rack as the main region and the main rack, respectively. The disclosed system transfers D₁, D₃, R₁, and R₃ to the main rack to decode D₅ and D₇. The disclosed system re-distributes D₇ to another rack. Finally, the disclosed system executes two column repairs to decode C₃ and D₈ 503. The multi-block repair transfers one cross-rack block and four cross-region blocks.

We elaborate on the repair for rack failures. A failed rack implies a column of failed blocks (including k₂ data blocks and m₂ column parity blocks). Using the progressive multi-block repair, the disclosed system first performs k₂ row repairs for the k₂ data blocks (which can be executed in parallel), so that the disclosed system can later perform a column repair to decode the m₂ column parity blocks locally within the failed rack. Note that there is only one failed block in each row repair, so the disclosed system applies partial decoding.

The numbers of cross-rack and cross-region blocks are

$${k}_{1} {k}_{2} - \frac{{k}_{1} {k}_{2}}{{m}_{1}} and \frac{{k}_{1} {k}_{2}}{{m}_{1}} ,$$

respectively.

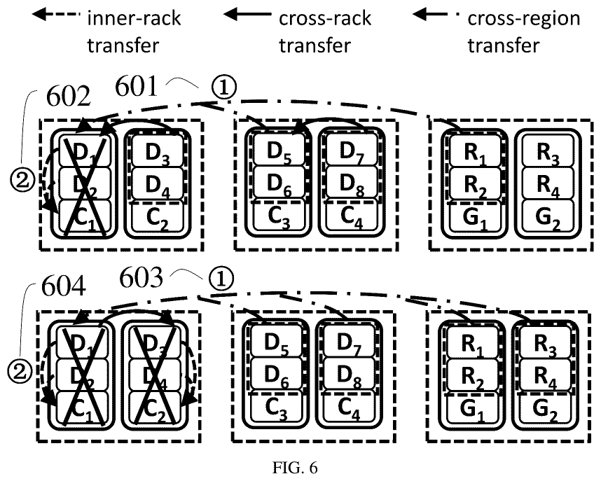

For example, in FIG. 6, in order to repair the blocks of the first rack, the disclosed system performs two row repairs to decode D₁ and D₂ 601. Then, the disclosed system performs a column repair to decode C₁ locally in the failed rack 602. The rack repair transfers four cross-region blocks and four cross-rack blocks.

We elaborate on the repair for region failures. A failed region implies m₁ failed columns (i.e., k₂m₁ data blocks and m₁m₂ column parity blocks). Using the progressive multi-block repair, the disclosed system first performs k₂ row repairs for the k₂m₁ data blocks, and later performs m₁ column repairs to decode the m₁m₂ column parity blocks. The disclosed system excludes partial decoding as there are m₁ failed blocks in each row repair. The numbers of cross-rack and cross-region blocks are m₁k₂−k₂ and k₁k₂, respectively.

For example, in FIG. 6, to repair all blocks in the first region, the disclosed system performs two row repairs to decode D₁ to D₄ 603. Then, the disclosed system performs two column repairs to decode C₁ and C₂ locally within each rack 604. The region repair transfers eight cross-region blocks and two cross-rack blocks.

We show that all types of block repairs minimize the sum of cross-rack and cross-region transfers, i.e., the cross-rack and cross-region repair traffic, is optimal.

For every single-block repair and repair of up to m₂ blocks within the same column, they can locally complete within a rack without any cross-rack and cross-region transfer and hence are optimal.

For multi-block repair, in each round of column repairs 706 and single row repair 709 in the disclosed data repairing method in FIG. 7, the disclosed system always executes the most column repairs but only one row repair with the maximum number of repairable failed blocks. The selection of a row in a round enables more column repairs in the next round. Overall, the disclosed system executes the maximum number of column repairs and the minimum number of row repairs in a multi-block repair.

On the other hand, if the disclosed system does not select the row with the maximum number of repairable failed blocks in a round, then the disclosed system needs at least two row repairs to maintain the same number of subsequent column repairs and the sum of cross-rack and cross-region transfers increases (the number of row repairs also increases). Thus, we can deduce that all row repairs minimize the sum of cross-rack and cross-region transfers. To elaborate, we revisit the example in FIG. 5. After executing two column repairs for D₁ and D₄ 501, the disclosed system selects the first row and performs a row repair to decode D₅ and D₇ 502. This single row repair transfers one cross-rack block and four cross-region blocks. If the first row is not selected, then two row repairs needs to be executed to decode C₃ and D₈, so that two column repairs for D₅ and D₇ is feasible. As the result, the two row repairs transfer four cross-rack blocks and four cross-region blocks (i.e., more transferred blocks).

Finally, both rack repair and region repair are in essence multi-block repairs. The optimality of multi-block repairs can be applied to both rack and region repairs.

What is claimed:

1. A data management system, comprising:
a plurality of storage nodes,
a plurality of racks,
a plurality of regions,
a plurality of networks;
wherein each of the said plurality of racks comprises at least k₂+m₂ storage nodes, where k₂ and m₂ are positive integers;
wherein each of the said plurality of regions comprises m₁ of the said plurality of racks, where m₁ is a positive integer;
wherein all the pluralities of storage nodes, racks, and regions, are connected via the said plurality of networks;
wherein a unit of input data is divided into a set of data blocks;
wherein all blocks in the said set of data blocks are arranged in a two-dimensional array of k₁ columns and k₂ rows, where k₁ is a positive integer;
wherein all said data blocks in the same row are encoded into m₁ row parity blocks using an erasure code, where m₁ is a positive integer;
wherein m₁ columns are added to the said two-dimensional array and one of the said row parity blocks in a row is added to each of the additional m₁ columns;
wherein all said data blocks in the same column are encoded into m₂ column parity blocks using an erasure code;
wherein m₂ rows are added to the said two-dimensional array and one of the said column parity blocks in a column is added to each of the additional m₂ rows;
wherein each of the said plurality of racks stores all said data blocks, said row parity blocks, and said column parity blocks in a said column;
wherein each of the said plurality of racks stores at most one block in the set of said data blocks, said row parity blocks, and said column parity blocks in a said row;
wherein each of the said plurality of storage nodes stores at most one block in the set of said data blocks, said row parity blocks, and said column parity blocks for each said unit of input data.

2. The system of claim 1,
wherein the said column parity blocks of the said same row are encoded into m₁ global parity blocks using an erasure code;
wherein one of the said global parity blocks of a row is added to each of the said m₁ columns of row parity blocks;
wherein each of the said plurality of racks stores all said data blocks, said row parity blocks, said column parity blocks, and said global parity blocks in a said column;
wherein each of the said plurality of racks stores at most one block in the set of said data blocks, said row parity blocks, said column parity blocks, and said global parity blocks in a said row;
wherein each of the said plurality of storage nodes stores at most one block in the set of said data blocks, said row parity blocks, said column parity blocks, and said global parity blocks for each said unit of input data.

3. The system of claim 1,
wherein all said row parity blocks of the same said column are encoded into m₂ global parity blocks using an erasure code;
wherein one of the said global parity blocks of a column is added to each of the said m₂ rows of column parity blocks;
wherein each of the said plurality of racks stores all said data blocks, said row parity blocks, said column parity blocks, and said global parity blocks in a said column;
wherein each of the said plurality of racks stores at most one block in the set of said data blocks, said row parity blocks, said column parity blocks, and said global parity blocks in a said row;
wherein each of the said plurality of storage nodes stores at most one block in the set of said data blocks, said row parity blocks, said column parity blocks, and said global parity blocks for each said unit of input data.

4. A data repairing method, comprising taking a unit of input data with failed blocks as input;
checking and reporting data loss if the said set of failed blocks forms a grid that spans (m₂+1) adjacent rows and (m₁+1) adjacent columns, which indicates the set of failed blocks cannot be repaired;
finding all columns with no more than m₂ failed blocks and repairing failed blocks in these columns in parallel;
finding the rows with no more than m₁ failed blocks, selecting the row with the maximum number of failed blocks, and repairing all failed blocks in the said selected row;
repeating the third and fourth steps until all blocks in the said set of failed blocks for a unit of input data are repaired.

5. A data repairing method, comprising taking a row of blocks that has f failed blocks as input, where f is a positive integer;
selecting a region as the main region and a rack as the main rack;
selecting the smallest number of helper regions, such that the total number of surviving blocks in this row in all said helper regions and the said main region is at least k₁;
transferring k₁ surviving blocks to the said main rack either when f>1 or when f=1 and the number of surviving blocks in each of the said helper regions equals one;
selecting a rack that stores at least one surviving block in each of the said helper regions as the relay, collecting other surviving blocks in racks within the same region at each of the said relays, computing a partially decoded block at each of the said relays using an erasure code and the said collected surviving blocks at each of the said relays, and transferring all said partially decoded blocks to the said main rack, when f=1 and the number of surviving blocks in each of the said helper regions is greater than one;
decoding all of the said f failed blocks in the said row of blocks in the said main rack;
redistributing the said decoded f blocks from the said main rack to other racks and regions.
